(19) United States
(12) Patent Application Publication
(10) Pub. No.: US 2025/0265191 A1
(43) Pub. Date: Aug. 21, 2025

(54) SYSTEMS, METHODS, AND APPARATUS FOR MANAGING OCCUPANCY IN MEMORY CACHES

(71) Applicant: Samsung Electronics Co., Ltd., Suwon-si (KR)

(72) Inventors: Marie Mai NGUYEN, Pittsburgh, PA (US); Usman SAJID, San Jose, CA (US); Joon Hee CHOI, Campbell, CA (US); Chiho CHOI, San Jose, CA (US); Zongwang LI, Dublin, CA (US); Rekha PITCHUMANI, Oak Hill, VA (US); Yang Seok KI, Palo Alto, CA (US)

(21) Appl. No.: 19/046,505

(22) Filed: Feb. 5, 2025

Related U.S. Application Data
(60) Provisional application No. 63/556,388, filed on Feb. 21, 2024.

(51) Int. Cl. G06F 12/0802

(52) U.S. Cl. CPC G06F 12/0802

(57) ABSTRACT

A device may include cache media and at least one processor configured to perform one or more operations including modifying a cache management policy based on a cache occupancy of the cache media, receiving data, and placing the data in the cache media based on the cache management policy. Placing the data in the cache media may include determining a set in the cache media based on the cache management policy and a memory address associated with the data and placing the data in the set. The memory address may include an index and a tag, and the index and tag may be used to determine a location in the cache media for the data. The at least one processor may further be configured to monitor the cache occupancy of the cache media, and modify the cache management policy based on the cache occupancy. The cache management policy may be configurable by a host.

### REFERENCE TO RELATED APPLICATION

This application claims priority to, and the benefit of, U.S. Provisional Patent Application Ser. No. 63/556,388, filed on Feb. 21, 2024, which is incorporated by reference.

### TECHNICAL FIELD

This disclosure relates generally to memory caches, and more specifically to systems, methods, and apparatus for managing occupancy in memory caches.

### BACKGROUND

A storage device may include a cache to temporarily store data in faster memory. The amount of memory used in relation to the total available memory in the cache (e.g., the cache occupancy) may affect the performance, such as the access time, of the cache.

The above information disclosed in this Background section is only for enhancement of understanding of the background of the invention and therefore it may contain information that does not constitute prior art.

### SUMMARY

In some aspects, the techniques described herein relate to a device including cache media and an at least one processor configured to perform one or more operations including modifying a cache management policy based on a cache occupancy of the cache media, receiving data, and placing the data in the cache media based on the cache management policy. In some aspects, placing the data in the cache media includes determining a set in the cache media based on the cache management policy and a memory address associated with the data, and placing the data in the set. In some aspects, the at least one processor is further configured to perform one or more operations including receiving a memory address associated with the data, where the memory address includes an index and a tag, and the index and the tag are used to determine a location in the cache media for the data. In some aspects, modifying a cache management policy includes selecting a machine learning function for the cache management policy, and placing the data in the cache media includes selecting a set in the cache media based on the machine learning function. In some aspects, the at least one processor is further configured to perform one or more operations including monitoring the cache occupancy of the cache media, and modifying the cache management policy based on the cache occupancy. In some aspects, the at least one processor is further configured to perform one or more operations including determining that the cache occupancy satisfies a threshold value, and modifying the cache management policy. In some aspects, the cache management policy is configurable by a host. In some aspects, the at least one processor is further configured to perform one or more operations including receiving an input to set an interval value, where the interval value is used to monitor the cache occupancy of the cache media. In some aspects, the at least one processor is further configured to perform one or more operations including monitoring at least one of the cache occupancy, a number of hits, a number of accesses, or a hit rate.

In some aspects, the techniques described herein relate to a method including modifying a cache management policy based on a cache occupancy of cache media, receiving data to be placed in the cache media, and placing the data in the cache media based on the cache management policy. In some aspects, placing the data includes determining a set in the cache media based on the cache management policy and a memory address associated with the data, and placing the data in the set. In some aspects, the memory address includes an index and a tag, where the set is determined using the index and the tag. In some aspects, placing the data includes using a machine learning function to place the data. In some aspects, the method further includes monitoring the cache occupancy, and modifying the cache management policy based on the cache occupancy. In some aspects, the cache management policy is configurable by a host. In some aspects, the method further includes receiving an input to set a threshold value, and modifying the cache management policy based on the threshold value.

In some aspects, the techniques described herein relate to a system including a host device including an interface; and a storage device including cache media and at least one processor configured to perform one or more operations including modifying a cache management policy based on a cache occupancy of the cache media, receiving data, and placing the data in the cache media based on the cache management policy. In some aspects, the interface is configured to perform one or more operations including enabling the at least one processor to modify the cache management policy. In some aspects, the interface is configured to perform one or more operations including setting a threshold value, where the threshold value is used to determine whether to change the cache management policy. In some aspects, the interface is configured to perform one or more operations including setting an interval value, where the interval value is used to monitor the cache occupancy of the cache media.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1a illustrates an embodiment of a storage device scheme in accordance with example embodiments of the disclosure.

FIG. 1b illustrates another embodiment of a storage device scheme in accordance with example embodiments of the disclosure.

FIG. 2 illustrates an example of a caching scheme in accordance with example embodiments of the disclosure.

FIG. 3 illustrates another example of a caching scheme in accordance with example embodiments of the disclosure.

FIG. 4 illustrates a flowchart of dynamically selecting a cache occupancy function in accordance with example embodiments of the disclosure.

FIG. 5 illustrates an example machine learning function for selecting a cache set in accordance with example embodiments of the disclosure.

FIG. 6 illustrates another example machine learning function for selecting a cache set in accordance with example embodiments of the disclosure.

FIG. 7 illustrates a flowchart of a method for placing data in a cache based on a cache management policy in accordance with example embodiments of the disclosure.

FIG. 8 illustrates another embodiment of a storage device scheme in accordance with example embodiments of the disclosure.

### DETAILED DESCRIPTION

Generally, accesses to memory media (e.g., cache media) may be performed faster than accesses to storage media. Thus, it may be beneficial to populate the memory media with data that is more frequently accessed and/or data that will be accessed sooner. A storage device may use a cache management policy to determine how the memory media is populated. For example, some storage devices may use a set-associative cache, where the data may be written to a specific set of the cache based on, e.g., an index of the data to be written. However, the cache management policy may not efficiently populate the memory media, causing the performance of the system to be affected, when some sets are written to more frequently than other sets and/or when the data in the set needs to be replaced when a set is full.

According to embodiments of the disclosure, a cache occupancy module may provide alternate ways for data to be placed in sets of the memory media. For example, in some embodiments, the cache occupancy module may improve the cache occupancy (e.g., the number of used cache blocks over the total number of cache blocks) of a cache by providing a function to place data in alternate sets of the cache (i.e., use another way to determine a set than using the index of the data). In some embodiments, a host may select a function to compute the set value and/or the cache occupancy module may monitor cache occupancy and change the function as needed to increase cache occupancy. This may allow for improved cache occupancy, cache hit rate and/or end-to-end application performance.

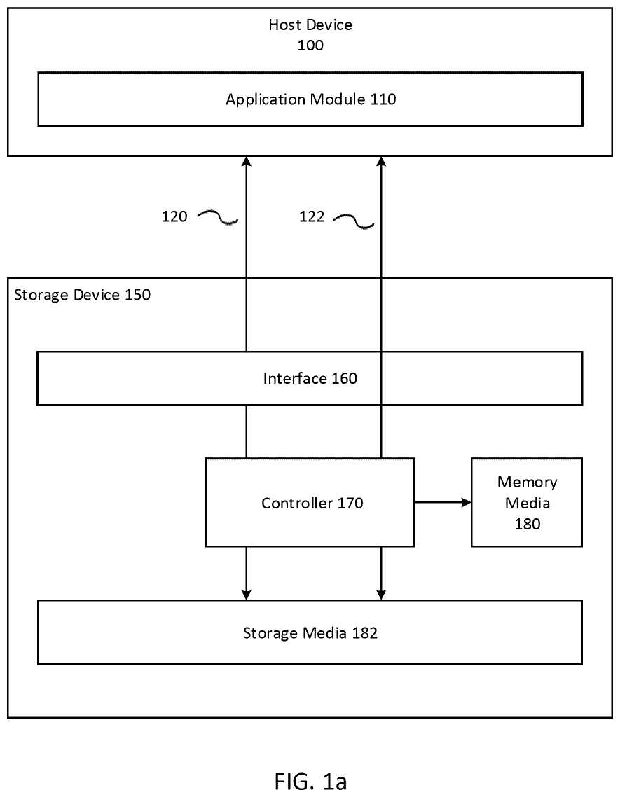

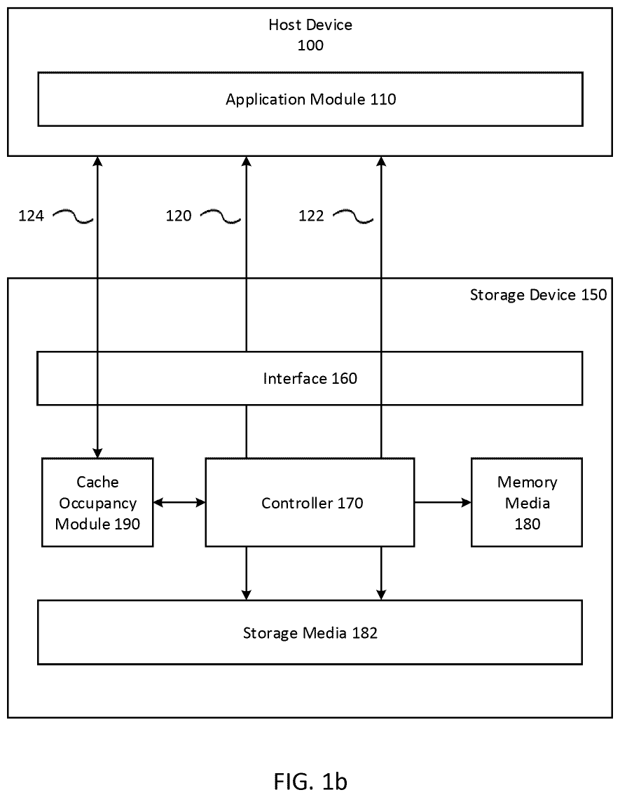

FIG. 1a illustrates an embodiment of a storage device scheme in accordance with example embodiments of the disclosure. In some embodiments, the storage device may be a dual- mode storage device (e.g., the storage device that may support input/output (I/O) block accesses and memory accesses). The embodiment illustrated in FIG. 1a may include one or more host devices 100 and/or one or more storage devices 150. In some embodiments, a host device 100 may include an application module 110; and a storage device 150 may include an interface 160, controller 170, memory media 180 (e.g., cache media), and/or storage media 182. In some embodiments, the interface 160 and/or controller 170 may be implemented on one or more circuits of the storage device 150. In some embodiments, the one or more circuits may include one or more field programmable gate arrays (FPGAs), application specific integrated circuits (ASICs), and/or systems on a chip (SoCs).

In some embodiments, the memory media 180 may be relatively fast memory such as dynamic random-access memory (DRAM) and the storage media 182 may be slower non-volatile memory, such as not-AND (NAND) flash memory. In some embodiments, the memory media 180 may be used as a cache to temporarily store data in the faster memory. In some embodiments, the application module 110 may run an application that may access data from the storage device 150 in at least two ways. In some embodiments, the application module 110 may request data from the storage device 150 by using an I/O block access request 120 (e.g., CXL.io) to retrieve data from the storage media 182. In some embodiments, the application module 110 may use a memory access request 122 (e.g., CXL.mem) received at the controller 170 to retrieve data from the memory media 180. In particular, in some embodiments, in response to receiving a memory access request 122, the storage device 150 may send a request to the controller 170 to check the memory media 180 for data corresponding to the request. In some embodiments, in response to a cache hit (e.g., the data is found on the memory media 180), the data may be returned from the memory media 180. In some embodiments, in response to a cache miss (e.g., the data is not found on the memory media 180), the controller 170 may copy the data from the storage media 182 to the memory media 180 and return the data from the memory media 180. In some embodiments, an I/O block access request 120 may allow a host device 100 to access the storage media 182 using general read and write commands, and a memory access request 122 may allow the host to access the memory media 180 using load and store commands.

For illustrative purposes, the storage media 182 may be 512 gigabytes (GB), and the memory media 180 may be 16 GB. In some embodiments, the size of the memory media 180 (e.g., 16 GB) may be small relative to the size of the storage media 182 (e.g., 512 GB), and the controller 170 may replace data on the memory media 180 to load data stored on the storage media 182 and/or host device 100. In some embodiments, as data is replaced on the memory media 180, existing data on the memory media 180 may be erased to make room for the new data. Thus, for example, in some embodiments, data may be copied from the storage media 182 to the memory media 180 as needed. In some embodiments, the storage device 150 may use a cache management policy to write data to the memory media 180. For example, in some embodiments, for a set-associative cache, the cache management policy may indicate to which set the data (e.g., location in the cache) may be written. In some embodiments, the cache management policy may be used to improve the performance of the storage device 150 as viewed by the host device 100. In some embodiments, the memory media 180 may be underutilized due to some sets being written to more frequently than other set (e.g., the memory media 180 may not be fully utilized depending on the workload and/or access pattern).

FIG. 1b illustrates another embodiment of a storage device scheme in accordance with example embodiments of the disclosure. The elements illustrated in FIG. 1b may be similar elements to those illustrated in FIG. 1a in which similar elements may be indicated by reference numbers ending in, and/or containing, the same digits, letters, and/or the like. In some embodiments, a storage device 150 may further include a cache occupancy module 190. In some embodiments, the cache occupancy module 190 may allow the storage device 150 to modify the way that the cache is populated. For example, the cache occupancy module 190 may provide additional functions that may be applied to the cache management policy to determine a set to which data is written. Thus, in some embodiments, by modifying the cache management policy, the memory media 180 may be populated more efficiently. In some embodiments, the cache occupancy module 190 may have two operation modes: static and dynamic. In some embodiments, a static mode may allow the cache to be populated in a default mode (i.e., the cache is populated using a function set by the user or operating system). In some embodiments, a dynamic mode may allow the storage device 150 to dynamically monitor the cache occupancy and change the function to use, e.g., a function such as a round-robin function to increase the cache occupancy. FIG. 1b shows the cache occupancy module 190 as a separate module. However, it should be understood that the cache occupancy module 190 may be implemented as part of the controller 170 or any component of the storage device that may receive information on the memory media 180. In some embodiments, the cache occupancy module 190 may communicate with the host device 100 using an I/O block access request 120 (e.g., CXL.io). For example, the cache occupancy module 190 may send to the host device 100 cache statistics for the user and/or host to set a cache occupancy function, set a threshold value and/or set and interval, among others.

In some embodiments, the cache occupancy module 190 may be implemented on one or more processors of the storage device 150. In some embodiments, the cache occupancy module 190 may be on its own processor or be part of a processor that may handle additional functionality for the storage device 150. In some embodiments, the cache occupancy module 190 may be implemented on one or more FPGAs, ASICs, and/or SoCs. In some embodiments, the cache occupancy module 190 may be implemented with hardware, software, or a combination thereof including combinational logic, sequential logic, one or more timers, counters, registers, and/or state machines, one or more complex programmable logic devices (CPLDs), central processing units (CPUs) such as complex instruction set computer (CISC) processors such as x86 processors and/or reduced instruction set computer (RISC) processors such as ARM processors, graphics processing units (GPUs), data processing units (DPUs), neural processing units (NPUs), tensor processing units (TPUs), and/or the like, executing instructions stored in any type of memory, or any combination thereof.

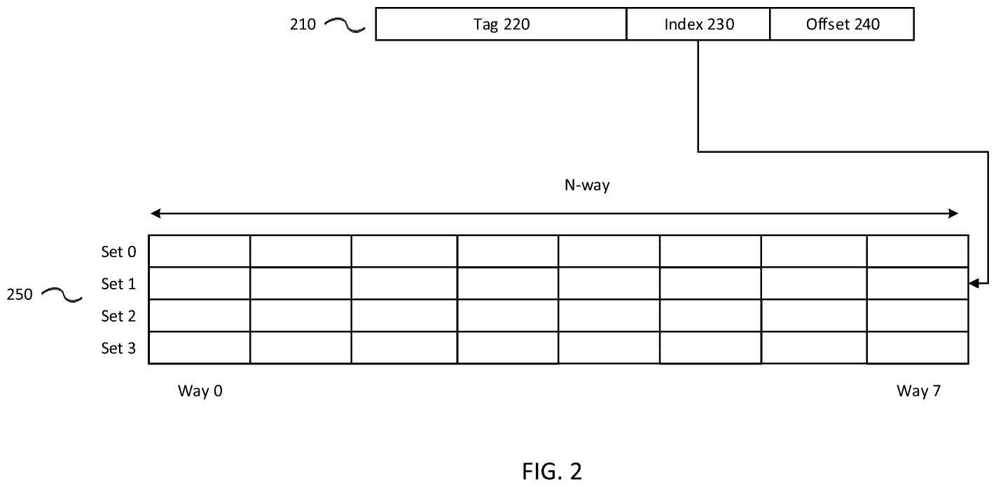

FIG. 2 illustrates an example of a cache scheme in accordance with example embodiments of the disclosure. The embodiment illustrated in FIG. 2 may include one or more memory addresses 210 and a cache 250. In some embodiments, the cache 250 may be a set-associative cache. Although, the cache 250 is described as a set-associative cache, the cache 250 may be any type of cache that organizes memory addresses in block and/or sets.

In some embodiments, the cache 250 may be organized into a number of sets. For example, as illustrated in FIG. 2, a cache may be organized in four sets (e.g., set 0, set 1, set 2, and set 3). In some embodiments, each set may be organized further into blocks. For example, a set may be organized as eight blocks and/or ways (e.g., way 0 to way 7). In some embodiments, a memory address may map to a particular set. For example, a memory address 210 may include a tag 220, index 230, and offset 240. In some embodiments, the index 230 may be used to determine which set in the cache 250 data may be placed (e.g., the index 230 may correspond to a set). For example, if the index 230 is a 2-bit value, “00” may map to set 0, “01” may map to set 1, “10” may map to set 2, and “11” may map to set 3. In some embodiments, if the value of bits is larger than the number of sets, multiple values of bits may be mapped to a corresponding set.

In some embodiments, a memory address 210 may be used to place data in any block of the set. For example, if a set has eight blocks, data may be placed in any of the eight blocks. In some embodiments, the data may be placed in an empty block or replace a block with existing data. In some embodiments, the cache management policy may determine how the data is written to blocks. However, in some embodiments, the memory address 210 may map to a specific set (i.e., the value of the memory address 210 may indicate to which set the data may be placed).

In some embodiments, memory in the cache 250 may be organized by set. In some embodiments, when data is placed in the cache 250, the data may be placed in any block of the set. If a block is not free, the data may replace existing data in a block based on a cache replacement policy of the set. For example, the cache 250 may use a least recently used (LRU) replacement policy.

In some embodiments, the tag 220, index 230, and offset 240 may be a number of bits. For example, the memory address 210 may be a 64-bit address, and the tag 220, index 230, and offset 240 may be values in the memory address 210. In some embodiments, the index 230 may be a bitwise value. For example, if the cache 250 has four sets, the index 230 may be a two-bit value. In some embodiments, if the cache 250 has more sets, the index 230 may be a larger number of bits. In some embodiments, if the index 230 the memory address 210 has a bit value of 0, the data may be written to the first set in the cache 250. In some embodiments, the number of bits may be based on the size of the cache 250. For example, if the cache 250 is 16 GB, the number of blocks per set is eight, and a block size is 4 kilobytes, the number of sets may be 524,288. Thus, in some embodiments, the offset 240 may be 12 bits (e.g., bits 0-11), the index 230 may be 19 bits (e.g., bits 12-30), and the tag 220 may be 33 bits (e.g., bits 31-63).

In some embodiments, when the index 230 maps to a set, some sets may be overly accessed while others are underutilized. In some embodiments, the default function may be for the index 230 to correspond to the set. However, in some embodiments, a different function may be used to select a set for the data. For example, in some embodiments, a function may use the index 230 and the offset 240 to determine the set (e.g., the index 230 may be added to tag 220 and/or the index 230 may be subtracted from the tag 220). In some embodiments, a function may use a machine learning (ML) model to determine the set. It should be understood that other functions may also be used to determine the set. For example, any function that can be used to correspond a memory address to a set may be used.

In some embodiments, the tag 220 may be used to determine if data is found in the set. For example, the tag 220 may be compared with the data in the set, and if a match occurs (e.g., cache hit), the data may be returned from the cache.

In some embodiments, the function to determine a set may be selected by a user or may be dynamically selected. For example, a module (such as the cache occupancy module 190 in FIG. 1b) may monitor the cache occupancy and change the function to use in a round-robin fashion to increase the cache occupancy. Although a round-robin algorithm is described, it should be understood that any algorithm to select a next function may be used. For example, a weighted round robin or random algorithm may be used to select a next function.

In some embodiments, a user interface may be provided for a user to select the function. For example, as described in further detail below, functions may be provided to return information that may be used to select the function and/or to select the function. In some embodiments, the host may call the functions to return the information and/or select the function. In some embodiments, cache statistics, such as the cache hit rate and/or cache occupancy may be provided to the user. In some embodiments, the user may change the module parameters, e.g., so that when the module dynamically selects the function, the module may change functions more or less frequently based on the parameters. In some embodiments, the user may select the interval for which the cache occupancy module checks the cache occupancy. For example, the user may set the interval for 10 minutes so that the cache occupancy module checks the cache occupancy every 10 minutes.

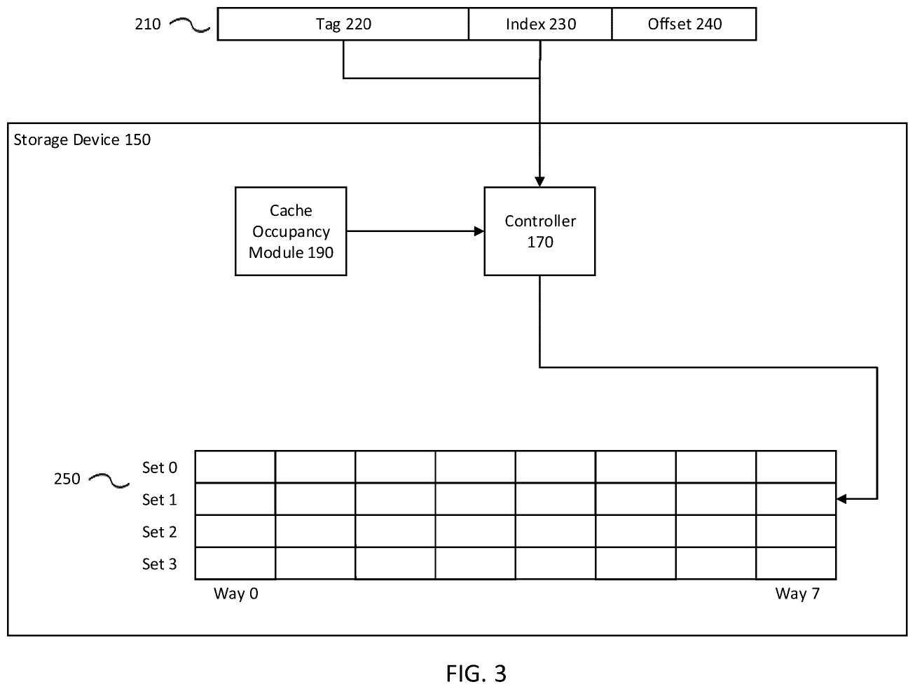

FIG. 3 illustrates another example of a cache scheme in accordance with example embodiments of the disclosure. The elements illustrated in FIG. 3 may be similar elements to those illustrated in FIGS. 1a, 1b, and 2 in which similar elements may be indicated by reference numbers ending in, and/or containing, the same digits, letters, and/or the like. In some embodiments, the cache occupancy module 190 may change the cache management policy for set placement. For example, the cache occupancy module 190 may change the cache management policy from using the index 230 for set placement to using a value based on the index 230 and the tag 220 (e.g., adding the index 230 and the tag 220) to obtain a set number. In some embodiments, when data is being written to the cache 250, the new cache management policy may be applied to the data to select a set in the cache 250. By using the index 230 and the tag 220, the selection of sets of the cache 250 may be spread more widely, allowing for improved efficiency in populating the cache 250. Although, the example in FIG. 3 describes using the tag 220 and the index 230, it should be understood that other portions of a memory address may be used. For example, the tag 220, the index 230, and the offset 240 may be used to obtain the set number. In some embodiments, the tag 220 and the offset 240 may be used to obtain the set number. In some embodiments, the cache may be flushed (i.e., data removed from the cache) before setting a new cache management policy. In some embodiments, the storage device may keep track of which cache management policy has been applied to which data so that multiple cache management policies may be applied.

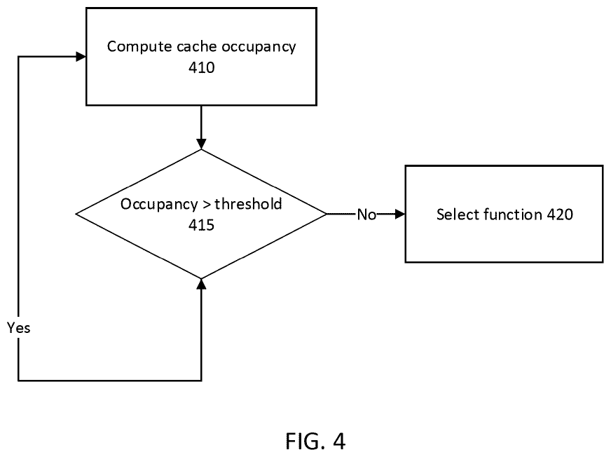

FIG. 4 illustrates a flow for dynamic mode operation in accordance with example embodiments of the disclosure. At 410, the cache occupancy may be computed. For example, in some embodiments, the cache occupancy for each set of the cache (such as the memory media 180 in FIG. 1b) may be calculated. In some embodiments, the cache occupancy may be computed after a number of memory accesses. In some embodiments, the number of memory accesses may be input by a user (e.g., by changing the module parameters as described in FIG. 2). At 415, whether the occupancy satisfies and/or is above a threshold (e.g., greater than a threshold value) may be determined. In some embodiments, the threshold may be set based on a performance measure of the cache. For example, an average latency may be calculated and compared with a threshold value. In some embodiments, the threshold may be input by a user (e.g., by changing the module parameters as described in FIG. 2). In some embodiments, if the cache occupancy is below the threshold, the cache occupancy will continue to be computed until the cache occupancy reaches the threshold. In some embodiments, if the occupancy is above the threshold, the cache occupancy module (such as the cache occupancy module 190 in FIG. 1b) may select another function (420) to determine a set for the data. For example, in some embodiments, the cache occupancy module may use a round-robin algorithm to determine a next function to compute the sets. In some embodiments, any of the functions for changing the cache policy may be used. In some embodiments, the host may select the next function to use. In some embodiments, when a next function is selected, the cache may be flushed before writing new data.

In some embodiments, a cache vacancy may be computed. For example, in some embodiments, after a number of writes or an interval, the cache may be examined. If one or more sets of the cache are underutilized, e.g., the cache vacancy satisfies and/or is below a threshold, a new function may be selected to write data to a set. In some embodiments, the cache may be flushed before applying the new function to the set. In some embodiments, both the cache occupancy and cache vacancy may be calculated and compared with their respective threshold values. In some embodiments, the next set may be selected with the cache occupancy is above a cache occupancy threshold and the cache vacancy is below a cache vacancy threshold. It should be understood that a particular threshold value may be used to check if a value is above or below the threshold value. Depending on the value to be compared with a threshold value, the value may be above in some circumstances and below in others. The threshold value should be understood to represent a value at which a state change or some other function may occur.

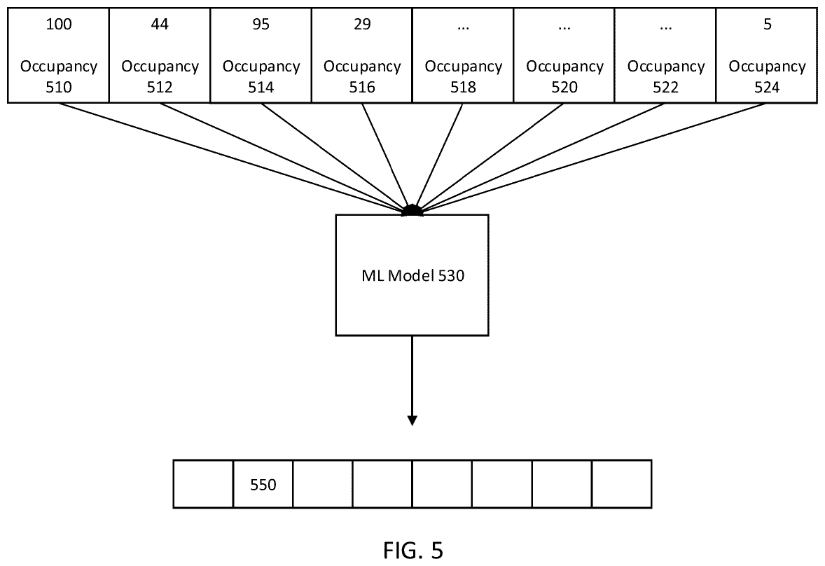

FIG. 5 illustrates an ML function that may be used to compute a set in accordance with example embodiments of the disclosure. In some embodiments, the occupancy for each set may be computed. For example, if the cache has eight sets, occupancies 510, 512, 514, 516, 518, 520, 522, and 524 may represent an occupancy percentage. In this example, occupancy 510 may be 100 percent, occupancy 512 may be 44 percent, occupancy 514 may be 95 percent, occupancy 516 may be 29 percent, etc. In some embodiments, the occupancies 510, 512, 514, 516, 518, 520, 522, and 524 may be used by a ML model 530 to compute a next set. For example, using the occupancies 510, 512, 514, 516, 518, 520, 522, and 524, the ML model 530 may select set 550 as the next set. In some embodiments, the ML model 530 may select a next set using criteria other than and/or in addition to cache occupancy. For example, in some embodiments, the ML model 530 may look at other localities (e.g., closeness of addresses) as well to determine the placement of data. In some embodiments, the ML model 530 may use the addresses of the data to be written to the cache. In other words, when the storage device reads a page of data, writing multiple blocks of data from the same page may reduce the number of accesses to the storage media. Thus, in some embodiments, the storage device may look to minimize the number of accesses by placing data that is close (e.g., closeness of addresses) in the same set. In some embodiments, the ML model 530 may initially be trained using seed data. In some embodiments, the cache data at a certain time and/or over a certain interval may be used to train the ML model 530. In some embodiments, the set to which data is written may be stored, e.g., as metadata, allowing for the retrieval of the data. In some embodiments, the metadata may be written to one or more circuits on the storage device. In some embodiments, the metadata may be retrieved from the one or more circuits to determine in which set the data is located. In some embodiments, the ML model 530 may be trained as needed. For example, the efficiency of the ML model 530 may be analyzed and the ML model 530 may be retrained when the efficiency is below a threshold.

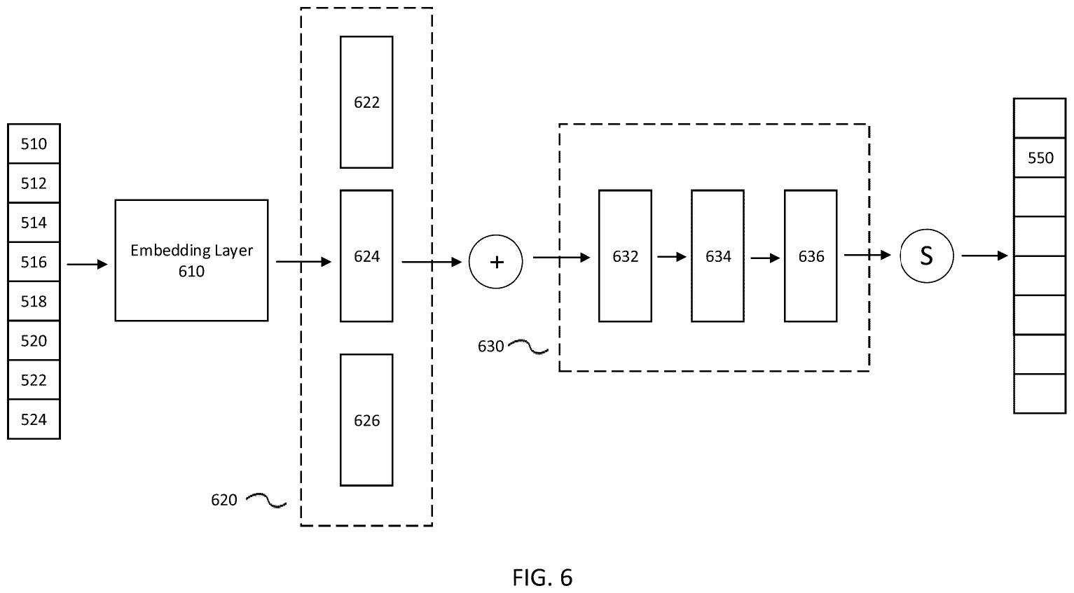

FIG. 6 illustrates another ML model that may be used to compute a set in accordance with example embodiments of the disclosure. In some embodiments, the ML model may use a neural network, and the neural network may by a deep learning neural network or any type of neural network. In some embodiments, the ML model may feed the occupancies 510, 512, 514, 516, 518, 520, 522, and 524 into an embedding layer 610 to obtain embeddings 622. In some embodiments, the occupancies 510, 512, 514, 516, 518, 520, 522, and 524 may be n-dimensions. In some embodiments, the dimensions may be determined by the number of inputs and/or features. In the example of FIG. 3, three embedding are illustrated (embedding 622, 624, and 626). However, it should be understood that there may be many more embeddings. For example, if an embedding represents a similarity of data, any number of similarities generated from the embedding layer 610 may be used. In some embodiments, the ML model may use vector addition to add the embeddings 620 and multi-level perceptrons (MLPs) 630 to obtain vector sums. In some embodiments, the MLPs may be interconnected so that a MLP may feed into another MLP. In some embodiments, the MLPs 630 (MLP 632, 634, and 636) may consider different features as input to the ML model. For example, occupancy, spatial locality, and/or metadata overhead can be used as input to compute values for the set. In some embodiments, the ML model may include weights and/or thresholds for the MLPs. In some embodiments, a softmax function (e.g., represented by the letter S) may be applied to the vector sums to compute the next set 550. Although in FIG. 6 a softmax figure is described, any function that may be used to generate a probability distribution may be used. In some embodiments, the ML model may be run until a threshold for a set has been met and/or a duration has elapsed.

In some embodiments, an interface may be provided for the user to configure the cache management policy or view cache statistic data. For example, in some embodiments, an enable_dynamic_mode(bool) command may be used to enable/disable the dynamic mode. In some embodiments, the default mode is static. In some embodiments, get_function_list( ) may get a list of available functions to compute the set. In some embodiments, set_function(id) may set the function with the id value to be used. In some embodiments, set_occupancy_threshold (threshold) may set the occupancy threshold to be the threshold value. In some embodiments, set_monitor_interval (interval) may set the monitoring interval to be the interval value. It should be understood that the function names are provided by way of example and the function names may be any name used to identify the function.

In some embodiments, cache statistics may also be provided via the interface. In some embodiments, the cache occupancy module may compute cache statistics in the background (i.e., without user interaction) and use that information to determine a next set. For example, the cache occupancy module may compute the cache occupancy, number of hits, number of accesses, and/or hit rate). In some embodiments, a user may access the results from memory-mapped I/O (MMIO) registers. In some embodiments, based on the cache statistics, a user may select the function depending on the workload. In some embodiments, get_cache_occupancy( ) may return the cache occupancy (e.g., the number of used blocks over the total number of blocks). In some embodiments, get_used_blocks( ) may return the number of used blocks. In some embodiments, get_total_access( ) may return the total number of accesses. In some embodiments, get_hit_rate( ) may return the cache hit rate (e.g., the number of hits over the number of total accesses). In some embodiments, get_hit( ) may return the number of hits. In some embodiments, get_total_access( ) may return the total number of accesses.

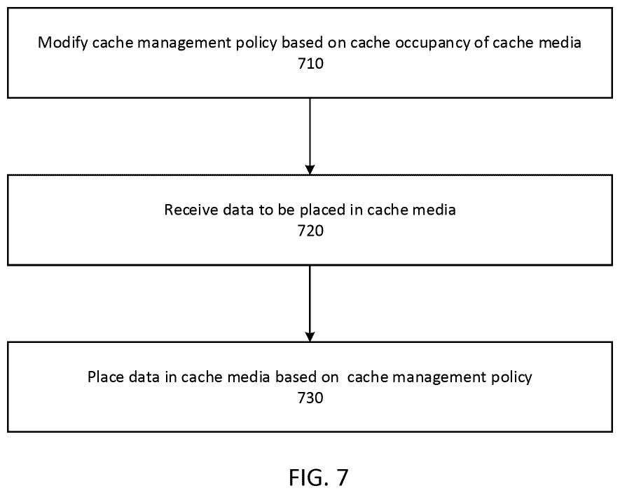

FIG. 7 illustrates a flowchart of a method for placing data in a cache based on a cache management policy in accordance with example embodiments of the disclosure. In some embodiments, at block 710, a cache management policy may be modified based on a cache occupancy of cache media. For example, the cache occupancy may be monitored, and when the cache occupancy satisfies and/or exceeds a threshold value, a new cache occupancy function may be selected to determine the cache management policy. In some embodiments, the modification of the cache management policy may be performed dynamically or manually. In some embodiments, the cache may be flushed before a new cache occupancy function is implemented for the cache management policy.

In some embodiments, at block 720, according to embodiments, a storage device may receive data to be placed in the cache media. In other words, the memory media on the storage device may receive a request to store data on the device. In some embodiments, the data may have a corresponding memory address, such as the memory address 210 in FIG. 2. Generally, for a set-associative cache, a memory address may have index bits that indicate to which set the data is written. For example, if the set bits have a value of zero, the data may be written to the corresponding set (e.g., set 0).

At block 730, according to embodiments, data may be placed in the memory media based on the cache management policy. For example, in some embodiments, the controller may be configured to place data in an alternate set based on a cache occupancy function. In some embodiments, the index bit and some other data (e.g., tag bits) may be used to determine a set. In some embodiments, if the value obtained from the tag bits and index bits is greater than the number of sets, the bits may be calculated to obtain a value less than the number of sets. In some embodiments, the controller may receive a function to determine the set from, e.g., a cache occupancy module, which may dynamically set the function based on the cache occupancy or be set by the user. In some embodiments, this may allow the storage device to place data in the cache more efficiently. Further, in some embodiments, the memory addresses from a host device need not be changed (the cache occupancy module and controller may determine the set from the memory address).

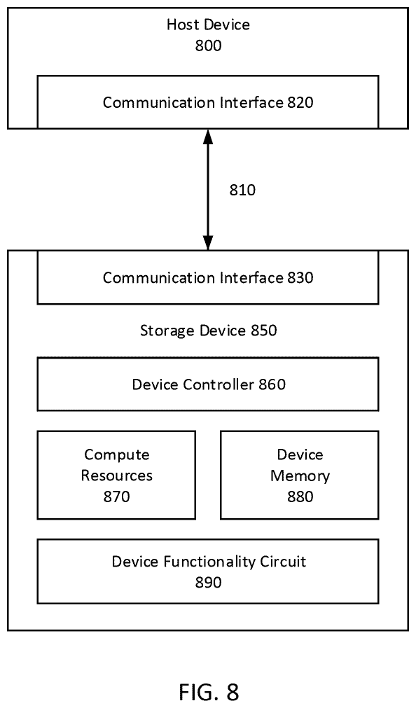

FIG. 8 illustrates an embodiment of a storage device scheme in accordance with example embodiments of the disclosure. The embodiment illustrated in FIG. 8 may include one or more host devices 800 and one or more storage devices 850 configured to communicate using one or more communication connections 810.

In some embodiments, a host device 800 may be implemented with any component or combination of components that may utilize one or more features of a storage device 850. For example, a host may be implemented with one or more of a server, a storage node, a compute node, a CPU, a workstation, a personal computer, a tablet computer, a smartphone, and/or the like, or multiples and/or combinations thereof.

In some embodiments, a storage device 850 may include a communication interface 830, memory 880 (some or all of which may be referred to as device memory), one or more compute resources 870 (which may also be referred to as computational resources), a device controller 860, and/or a device functionality circuit 890. In some embodiments, the device controller 860 may control the overall operation of the storage device 850 including any of the operations, features, and/or the like, described herein. For example, in some embodiments, the device controller 860 may parse, process, invoke, and/or the like, commands received from the host devices 800.

In some embodiments, the device functionality circuit 890 may include any hardware to implement the primary function of the storage device 850. For example, the device functionality circuit 890 may include storage media such as magnetic media (e.g., if the storage device 850 is implemented as a hard disk drive (HDD) or a tape drive), solid state media (e.g., one or more flash memory devices), optical media, and/or the like. For instance, in some embodiments, a storage device may be implemented at least partially as a solid-state drive (SSD) based on NAND flash memory, persistent memory (PMEM) such as cross-gridded nonvolatile memory, memory with bulk resistance change, phase change memory (PCM), or any combination thereof. In some embodiments, the device controller 860 may include a media translation layer such as a flash translation layer (FTL) for interfacing with one or more flash memory devices. In some embodiments, the storage device 850 may be implemented as a computational storage drive, a computational storage processor (CSP), and/or a computational storage array (CSA).

As another example, if the storage device 850 is implemented as an accelerator, the device functionality circuit 890 may include one or more accelerator circuits, memory circuits, and/or the like.

In some embodiments, the compute resources 870 may be implemented with any component or combination of components that may perform operations on data that may be received, stored, and/or generated at the storage device 850. Examples of compute engines may include combinational logic, sequential logic, timers, counters, registers, state machines, CPLDs, FPGAs, ASICs, embedded processors, microcontrollers, CPUs such as CISC processors (e.g., x86 processors) and/or a RISC processors such as ARM processors, GPUs, DPUs, NPUs, TPUs, and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

In some embodiments, the memory 880 may be used, for example, by one or more of the compute resources 870 to store input data, output data (e.g., computation results), intermediate data, transitional data, and/or the like. The memory 880 may be implemented, for example, with volatile memory such as DRAM, static random-access memory (SRAM), and/or the like, as well as any other type of memory such as non-volatile memory.

In some embodiments, the memory 880 and/or compute resources 870 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 880 and/or compute resources 870. In some embodiments, software, instructions, programs, code, and/or the like, may be downloaded, uploaded, sideloaded, pre-installed, built-in, and/or the like, to the memory 880 and/or compute resources 870. In some embodiments, the storage device 850 may receive one or more instructions, commands, and/or the like, to select, enable, activate, execute, and/or the like, software, instructions, programs, code, and/or the like. Examples of computational operations, functions, and/or the like, that may be implemented by the memory 880, compute resources 870, software, instructions, programs, code, and/or the like, may include any type of function, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (AI), ML, neural networks, and/or the like.

In some embodiments, a communication interface 820 at a host device 800, a communication interface 830 at a storage device 850, and/or a communication connection 810 may implement, and/or be implemented with, one or more interconnects, one or more networks, a network of networks (e.g., the internet), and/or the like, or a combination thereof, using any type of interface, protocol, and/or the like. For example, the communication connection 810, and/or one or more of the interfaces 820 and/or 830 may implement, and/or be implemented with, any type of wired and/or wireless communication medium, interface, network, interconnect, protocol, and/or the like including Peripheral Component Interconnect Express (PCIe), nonvolatile memory express (NVMe), NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 810 may include one or more switches, hubs, nodes, routers, and/or the like.

In some embodiments, a storage device 850 may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCle card (e.g., PCIe expansion card) form factor including half-height (HH), half-length (HL), half-height, half-length (HHHL), and/or the like), Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

Any of the storage devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a storage device 850 may be implemented with any device that may include, or have access to, memory, storage media, and/or the like, to store data that may be processed by one or more compute resources 870. Examples may include memory expansion and/or buffer devices such as CXL type 2 and/or CXL type 3 devices, as well as CXL type 1 devices that may include memory, storage media, and/or the like.

This disclosure encompasses numerous aspects relating to devices with memory and storage configurations. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as devices implemented as memory devices that may use specific interfaces, protocols, and/or the like. However, the aspects of the disclosure are not limited to these or any other implementation details.

In some embodiments, cache media may be accessed using a memory interface and/or protocol such as double data rate (DDR) of any generation (e.g., DDR4, DDR5, etc.), DMA, RDMA, Open Memory Interface (OMI), CXL, Gen-Z, and/or the like, whereas storage media may be accessed using a storage interface and/or protocol such as serial ATA (SATA), Small Computer System Interface (SCSI), serial attached SCSI (SAS), NVMe, NVMe-oF, and/or the like.

Although some embodiments may be described in the context of cache media that may be implemented with cache media such as DRAM, in other embodiments, other types of media, e.g., storage media, may be used for cache media. For example, in some embodiments, some or all of the memory media 180 may be implemented with media other than cache media that may have one or more relative characteristics (e.g., relative to the storage media 182) that may make one or both more suitable for their respective functions. For instance, in some embodiments, the storage media 182 may have a relatively higher capacity, lower cost, and/or the like, whereas some or all of the memory media 180 may have relatively lower access latency that may make it relatively more suitable for use as a cache.

Storage device 150 as well as any other devices disclosed herein may be used in connection with one or more personal computers, smart phones, tablet computers, servers, server chassis, server racks, datarooms, datacenters, edge datacenters, mobile edge datacenters, and/or any combinations thereof.

Any of the functionality described herein, including any of the user functionality, device functionally, and/or the like (e.g., any of the control logic) may be implemented with hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, CPLDs, FPGAs, ASICs, CPUs including CISC processors such as x86 processors and/or RISC processors such as ARM processors, GPUs, NPUs, TPUs, DPUs, and/or the like, executing instructions stored in any type of memory. In some embodiments, one or more components may be implemented as an SoC.

Some embodiments disclosed above have been described in the context of various implementation details such as devices implemented as storage devices that may use specific interfaces, protocols, and/or the like, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

In some embodiments, a portion of an element may refer to less than, or all of, the element. A first portion of an element and a second portion of the element may refer to the same portions of the element. A first portion of an element and a second portion of the element may overlap (e.g., a portion of the first portion may be the same as a portion of the second portion).

In the embodiments described herein, the operations are example operations, and may involve various additional operations not explicitly illustrated. In some embodiments, some of the illustrated operations may be omitted. In some embodiments, one or more of the operations may be performed by components other than those illustrated herein. Additionally, in some embodiments, the temporal order of the operations may be varied. Moreover, the figures are not necessarily drawn to scale.

The principles disclosed herein may have independent utility and may be embodied individually, and not every embodiment may utilize every principle. However, the principles may also be embodied in various combinations, some of which may amplify the benefits of the individual principles in a synergistic manner.

In some embodiments, the latency of a storage device may refer to the delay between a storage device and the processor in accessing memory. Furthermore, latency may include delays caused by hardware such as the read-write speeds to access a storage device, and/or the structure of an arrayed storage device producing individual delays in reaching the individual elements of the array. For example, a first storage device in the form of DRAM may have a faster read/write speed than a second storage device in the form of a NAND device. Furthermore, the latency of a storage device may change over time based on conditions such as the relative network load, as well as performance of the storage device over time, and environmental factors such as changing temperature influencing delays on the signal path.

Although some example embodiments may be described in the context of specific implementation details such as a processing system that may implement a non-uniform memory access (NUMA) architecture, storage devices, and/or pools that may be connected to a processing system using an interconnect interface and/or protocol CXL, and/or the like, the principles are not limited to these example details and may be implemented using any other type of system architecture, interfaces, protocols, and/or the like. For example, in some embodiments, one or more storage devices may be connected using any type of interface and/or protocol including Peripheral Component Interconnect Express (PCIe), Nonvolatile Memory Express (NVMe), NVMe-over-fabric (NVMe oF), Advanced extensible Interface (AXI), Ultra Path Interconnect (UPI), Ethernet, Transmission Control Protocol/Internet Protocol (TCP/IP), remote direct memory access (RDMA), RDMA over Converged Ethernet (ROCE), FibreChannel, InfiniBand, Serial ATA (SATA), Small Computer Systems Interface (SCSI), Serial Attached SCSI (SAS), iWARP, and/or the like, or any combination thereof. In some embodiments, an interconnect interface may be implemented with one or more memory semantic and/or memory coherent interfaces and/or protocols including one or more CXL protocols such as CXL.mem, CXL.io, and/or CXL.cache, Gen-Z, Coherent Accelerator Processor Interface (CAPI), Cache Coherent Interconnect for Accelerators (CCIX), and/or the like, or any combination thereof. Any of the storage devices may be implemented with one or more of any type of storage device interface including DDR, DDR2, DDR3, DDR4, DDR5, LPDDRX, OMI, NVLink, High Bandwidth Memory (HBM), HBM2, HBM3, and/or the like.

In some embodiments, any of the storage devices, memory pools, hosts, and/or the like, or components thereof, may be implemented in any physical and/or electrical configuration and/or form factor such as a free-standing apparatus, an add-in card such as a PCle adapter or expansion card, a plug-in device, for example, that may plug into a connector and/or slot of a server chassis (e.g., a connector on a backplane and/or a midplane of a server or other apparatus), and/or the like. In some embodiments, any of the storage devices, memory pools, hosts, and/or the like, or components thereof, may be implemented in a form factor for a storage device such as 3.5 inch, 2.5 inch, 1.8 inch, M.2, Enterprise and Data Center SSD Form Factor (EDSFF), NF1, and/or the like, using any connector configuration for the interconnect interface such as a SATA connector, SCSI connector, SAS connector, M.2 connector, U.2 connector, U.3 connector, and/or the like. Any of the devices disclosed herein may be implemented entirely or partially with, and/or used in connection with, a server chassis, server rack, dataroom, datacenter, edge datacenter, mobile edge datacenter, and/or any combinations thereof. In some embodiments, any of the storage devices, memory pools, hosts, and/or the like, or components thereof, may be implemented as a CXL Type-1 device, a CXL Type-2 device, a CXL Type-3 device, and/or the like.

In some embodiments, any of the functionality described herein, including, for example, any of the logic to implement tiering, device selection, and/or the like, may be implemented with hardware, software, or a combination thereof including combinational logic, sequential logic, one or more timers, counters, registers, and/or state machines, one or more CPLD, FPGA, ASICs, CPU such as CISC processors such as x86 processors and/or RISC processors such as ARM processors, GPUs, NPUs, TPUs and/or the like, executing instructions stored in any type of memory, or any combination thereof. In some embodiments, one or more components may be implemented as an SoC.

In this disclosure, numerous specific details are set forth in order to provide a thorough understanding of the disclosure, but the disclosed aspects may be practiced without these specific details. In other instances, well-known methods, procedures, components, and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses should not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element or layer is referred to as being on, “connected to” or “coupled to” another element or layer, it can be directly on, connected, or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” may include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

The term “module” may refer to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), SoC, an assembly, and so forth. Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, e.g., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

While certain exemplary embodiments have been described and shown in the accompanying drawings, it should be understood that such embodiments are merely illustrative, and the scope of this disclosure is not limited to the embodiments described or illustrated herein. The invention may be modified in arrangement and detail without departing from the inventive concepts, and such changes and modifications are considered to fall within the scope of the following claims.

1. A device comprising:
cache media; and
at least one processor configured to perform one or more operations comprising:
modifying a cache management policy based on a cache occupancy of the cache media;
receiving data; and
placing the data in the cache media based on the cache management policy.

2. The device of claim 1, wherein placing the data in the cache media comprises:
determining a set in the cache media based on the cache management policy and a memory address associated with the data; and
placing the data in the set.

3. The device of claim 1, wherein the at least one processor is further configured to perform one or more operations comprising:
receiving a memory address associated with the data, wherein the memory address comprises an index and a tag, wherein the index and the tag are used to determine a location in the cache media for the data.

4. The device of claim 1, wherein modifying a cache management policy comprises selecting a machine learning function for the cache management policy; and
wherein placing the data in the cache media comprises selecting a set in the cache media based on the machine learning function.

5. The device of claim 1, wherein the at least one processor is further configured to perform one or more operations comprising:
monitoring the cache occupancy of the cache media; and
modifying the cache management policy based on the cache occupancy.

6. The device of claim 1, wherein the at least one processor is further configured to perform one or more operations comprising:
determining that the cache occupancy satisfies a threshold value; and
modifying the cache management policy.

7. The device of claim 1, wherein the cache management policy is configurable by a host.

8. The device of claim 1, wherein the at least one processor is further configured to perform one or more operations comprising:
receiving an input to set an interval value, wherein the interval value is used to monitor the cache occupancy of the cache media.

9. The device of claim 1, wherein the at least one processor is further configured to perform one or more operations comprising:
monitoring at least one of the cache occupancy, a number of hits, a number of accesses, or a hit rate.

10. A method comprising:
modifying a cache management policy based on a cache occupancy of cache media;
receiving data to be placed in the cache media; and
placing the data in the cache media based on the cache management policy.

11. The method of claim 10, wherein placing the data comprises:
determining a set in the cache media based on the cache management policy and a memory address associated with the data; and
placing the data in the set.

12. The method of claim 11, wherein the memory address comprises an index and a tag, and wherein the set is determined using the index and the tag.

13. The method of claim 10, wherein placing the data comprises using a machine learning function to place the data.

14. The method of claim 10, further comprising:
monitoring the cache occupancy; and
modifying the cache management policy based on the cache occupancy.

15. The method of claim 10, wherein the cache management policy is configurable by a host.

16. The method of claim 10, further comprising:
receiving an input to set a threshold value; and
modifying the cache management policy based on the threshold value.

17. A system comprising:
a host device comprising an interface; and
a storage device comprising:
cache media; and
at least one processor configured to perform one or more operations comprising:
modifying a cache management policy based on a cache occupancy of the cache media;
receiving data; and
placing the data in the cache media based on the cache management policy.

18. The system of claim 17, wherein the interface is configured to perform one or more operations comprising:
enabling the at least one processor to modify the cache management policy.

19. The system of claim 17, wherein the interface is configured to perform one or more operations comprising:
setting a threshold value, wherein the threshold value is used to determine whether to change the cache management policy.

20. The system of claim 17, wherein the interface is configured to perform one or more operations comprising:
setting an interval value, wherein the interval value is used to monitor the cache occupancy of the cache media.
